(19) United States
(12) Patent Application Publication
(10) Pub. No.: US 2002/0078044 A1
(43) Pub. Date: Jun. 20, 2002

(54) System for automatically classifying documents by category learning using a genetic algorithm and a term cluster and method thereof

(76) Inventors: Jong-Cheol Song, Seoul (KR); Beoung-Xu Moon, Taejon (KR); Hyun-Soo Chung, Taejon (KR); Gi-Chai Hong, Taejon (KR); So-Hyun Son, Pusan (KR); Seong-Yong Lee, Taejon (KR)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 09/846,473

(22) Filed: Apr. 30, 2001

(30) Foreign Application Priority Data
Dec. 19, 2000 (KR) 2000-78266

(51) Int. Cl. G06F 17/30

(52) U.S. Cl. 707/6

(57) ABSTRACT

The present invention relates to automatic document classification system and method by which categories for fields is learned in a genetic learning classifier for performing a learning process using a genetic algorithm, and documents are classified into respective field categories by inputting term clusters for a keyword of the documents in the genetic learning classifier, and a system for allowing a user to store a search word used in the search in a user profile and to input the keyword to the genetic learning classifier to determine an interested field of the user. The present invention can be utilized in an automatic classification of the document in a directory service used in the wet search system. Therefore, the present invention can improve the search efficiency by utilizing an interested field of the user when the user searches the search result later. As the present invention can learn the category and perform a learning process when a new field is generated, the system may provide an immediate and prompt service. Further, as the present invention can provide a field category for the search word that is to be used by the user, it can prevent the search result for homonyms and thus provide more exact search result.

### TECHNICAL FIELD

The invention relates generally to a system for automatically classifying documents and method thereof. More particularly, the present relates to a system for automatically classifying documents by category learning using a genetic algorithm and a term cluster, and method thereof.

### BACKGROUND OF THE INVENTION

As information communication through Internet becomes prevalent, the quantity of information being transferred has been rapidly increased. Accordingly, it becomes more difficult to retrieve the adequate information desired by users. In order to solve this problem, researches are being made to provide a method for classifying documents according to their categories so that users can easily and exactly retrieve the documents. Among them, a research of grouping documents by allocating an adequate category to the document to be classified under a predetermined classification scheme is being conducted.

In the research concerning the automatic classification of documents, various schemes such as retrieval, categorization, routing, filtering, clustering, etc are used as the document grouping method. Although many researches on the automatic document classification have been made, there has been no system for automatically classifying documents perfectly. As a method of learning the document clustering to automatically classify the documents must perform the learning process with respect to a new document, there are problems that the learning process takes a long time thus a prompt service could not be provided.

According to the most representative method of these conventional technologies, a document clustering is performed for entire documents and an automatic classification of the document is performed using an artificial intelligent scheme. The document classification by this document clustering technique gives weight values to the terms having a high separation degree between documents. Therefore, this method is efficient in document retrieval but is not advantageous in document classification in which the category separation is important.

In particular, as a system for performing document clustering performs a document clustering and a learning process using an artificial intelligence for entire documents collected by a web robot, there is a problem that it requires a long processing time. In addition, as it must perform the document clustering and learning process for all the additionally collected documents, there is a problem that a prompt service could not be provided under a current internet environment.

These prior arts will be briefly explained below.

First, there is an article entitled “Automatic Document Classification in A Hierarchic Classification Scheme by an Inverted Category Frequency” by Cho Kwang-jae and Kim Jun-Tae published in The Proceedings of Korean Information Science Society, Volume 24, No. 1. This article discloses a method of calculating index weight values for automatic classification of documents, which defines an inverted category frequency (ICF) reflecting the category separation of indexes. That is, the prior art discloses a method of classifying documents in the hierarchical classification scheme using ICF. The ICF is to give a high weight value to the term having high separation between respective categories, which is a more meaningful method for calculating a weight value than an inverted document frequency (IDF) (the number of total documents/the number of documents in which a given term is contained) with respect to document classification. In this article, a test of automatic document classification of the articles in the economy session of the Chosun Daily News (Seoul, Korea) and KTSET (test data collection for the research on the information retrieval of Korean-text documents) was performed. As a result of the experiment, it was found that the method using the ICF as the weight value is higher in the accuracy than the method using the IDF as the weight value.

Also, the ICF method proposed by the article shows an exact classification performance in both a plane classification scheme and a hierarchical classification scheme, however specially in the hierarchical classification scheme.

In addition, there is Korean Patent No. 10-2000-0029370 entitled “System and Method for Retrieving Documents using Automatic Document Summary” issued to NIB Soft Co., Ltd. The Technology of the '370 patent constructs a keyword database and a subject sentence database using automatic summary and then retrieves documents having the similar contents to the key document using a received key sentence. In other words, as the prior art can retrieve the document having the similar contents using the document itself as a retrieval key, it can rapidly find desired information at a time. Further, as the prior art can display summary information related to the subject of the document as a result of the document retrieval, it can rapidly find desired information without the inconvenience of confirming the retrieval result.

This type of document classification method includes steps of generating keyword information for each retrieval key document, giving a weight value to the documents for each keyword, giving a weight value to the document to be retrieved for each key sentence, and classifying the documents in the order of the total weight value obtained by adding the weight value for the keyword and the weight value for the key sentence as the document to be retrieved.

In addition, there is an article entitled “Performance Comparison of ID3 (Induction of Decision Tree) and Back Propagation in Document Classification by Mechanical Learning” by Yang Soo-Yeon and Lee Guen-Bae published in The Proceedings of Korean Information Science Society V.19, No.2 of. This article discloses a system for performing an induction work as one of decision trees, where the classification rules are represented as a tree. The article also discloses a neuro-network learning algorithm consisting of an input layer and an intermediate layer, and an output layer and using an error back propagation algorithm, by which necessary information can be learned and stored.

The process of classifying natural language documents using predetermined categories is very important in information retrieval and natural language processing system. However, previous researches into automatic document classification schemes have been performed by means of mechanical learning or knowledge engineering method. The above article compares and analyzes the methods of automatically classifying documents utilizing inductive leaning algorithm and back propagation algorithm, that have been widely studied as a first step of designing and implementing the document classification by a learning machine. Through these comparison and analysis, the prior art presents a parameter from which an optimal efficiency can be expected by monitoring variations in the performance according to the variations in the size of the learning data and the size of the characteristic set.

Also, there is an article entitled “Study On Solutions Using Gene Algorithm of Time Table Problem” by Ahn Jong-Il published in the Articles in Information Processing, Vol. 7, No. 6. This article presents an algorithm to setup a university timetable, which has multiple constraining factors and having been a subject of researches in artificial intelligence. For this purpose, the article defines a 2-types of edge graph so that time collision constraint and date collision constraint between two lectures can be simultaneously represented. Further, the article presents a method of solving the problems using a gene algorithm. Also it presents a method of performing a local retrieval in order to increase the efficiency of random retrieval. The article shows that using this method the retrieval cost can be reduced by about 71% with the repetition number of 10,000 times compared to the random retrieval method. That is, this article introduces the application fields of gene algorithms.

Also, there is an article entitled “Automatic Document Classification Using Relevance Of Terms” by Shin Jin-Seop and Lee Chang-Hoon published in Articles in Information Processing, Vol. 6, No. 9. This article presents an automatic document classification algorithm within the fields of user's interest using a correlation characteristic between terms. The automatic classification algorithm can be generally constructed as follows.

First, a TF*IDF algorithm is used to find a representative term. Second, a correlation calculation probability model is used in order to calculate relevance between tenns. Third, two terms having the highest correlation and other terms around them are formed as a single group, thus generating a profile. Fourth, the third process is repeated with respect to the two terms having next high correlation until a value lower than a threshold value is obtained. The above prior art evaluates how each of the generated profiles affects respective documents and compares it with an existing document classification algorithm to establish the validity of the algorithm.

### SUMMARY OF THE INVENTION

The present invention is contrived to solve the above problems and an object of the present invention is to provide automatic document classification system and method in which the categories of fields are learned by a genetic learning classifier for performing learning process using a genetic algorithm, and documents are classified according to the categories of fields by inputting term clusters for a keyword of the documents in the genetic learning classifier, and a system for allowing a user to store the keywords used in the search in a user profile and to input the keyword to the genetic learning classifier to determine an interested field of the user.

In order to accomplish the above objects, a system for automatically classifying documents according to the present invention is characterized in that it comprises a morpheme analyzer for receiving collected documents and link subjects to extract related terms; a term cluster generator for receiving the terms extracted by the morpheme analyzer to extract keywords per document, generating a keyword list per document and generating a term cluster; and a genetic learning classifier for receiving the keyword list and the term cluster generated by the term cluster generator to extract a term cluster for the keyword and for inducing a related field category for the extracted term cluster, wherein the genetic learning classifier learns the field category using a gene algorithm.

Further, a method of generating and changing a term cluster in a system for automatically classifying documents by a category learning technique using a genetic algorithm and a term cluster according to the present invention is characterized in that it comprises a first step of extracting a term in a collected document and a term included in a previously constructed comparison term list; a second step of calculating a term cluster coefficient using the value extracted in the first step; a third step of generating a term cluster using the term cluster coefficient calculated in the second step; and a fourth step of adding a term cluster index if the term cluster generated in the third step is a new term cluster, and updating an existing term cluster coefficient index and then adding the updated term cluster coefficient index to the term cluster index if the term cluster generated in the third step is not a new term cluster.

Also, a method of automatically classifying documents according to the present invention is characterized in that it comprises a first step of receiving collected documents and link subjects to extract related terms; a second step of receiving the terms extracted in the first step to extract keywords per document and generating a keyword list per document and a term cluster; and a third step of receiving the keyword list and the term cluster generated in the second step to extract a term cluster for the keyword and for inducing a related field category for the extracted term cluster using a genetic algorithm.

In addition, a computer-readable recording medium in which a program capable of executing a method of generating and changing a term cluster in a system for automatically classifying documents by a category learning using a genetic algorithm and a term cluster is recorded according to the present invention is characterized in that the program executes a first step of extracting a term of a collected document and a term included in a previously constructed comparison term list; a second step of calculating a term cluster coefficient using the resulting value extracted in the first step; a third step of generating a term cluster using the term cluster coefficient calculated in the second step; and a fourth step of adding a term cluster index if the term cluster generated in the third step is a new term cluster, and updating an existing term cluster coefficient index and then adding the updated term cluster coefficient index to the term cluster index if the term cluster generated in the third step is not a new term cluster.

Further, a computer-readable recording medium in which a program is recorded according to the present invention is characterized in that the program executes a first step of receiving collected documents and link subjects to extract related terms; a second step of receiving the terms extracted in the first step to extract keywords per document and generating a keyword list per document and a term cluster; and a third step of receiving the keyword list and the term cluster generated in the second step to extract a term cluster for the keyword and for inducing a related field category for the extracted term cluster using a genetic algorithm, wherein the third step further including a first sub-step of extracting a term of a collected document and a term included in a previously constructed comparison term list; a second sub-step of calculating a term cluster coefficient using the resulting value extracted in the first sub-step; a third sub-step of generating a term cluster using the term cluster coefficient calculated in the second sub-step; and a fourth sub-step of adding a term cluster index if the term cluster generated in the third step is a new term cluster, and updating an existing term cluster coefficient index and then adding the updated term cluster coefficient index to the term cluster index if the term cluster generated in the third sub-step is not a new term cluster.

### BRIEF DESCRIPTION OF THE DRAWINGS

The aforementioned aspects and other features of the present invention will be explained in the following description, taken in conjunction with the accompanying drawings, wherein:

FIG. 1 shows an overall structure of an automatic document classification system according to one embodiment of the present invention,

FIG. 2a and FIG. 2b are flowcharts of generation and change algorithm according to one embodiment of the present invention, wherein FIG. 2a is a flowchart showing the generation algorithm of a term cluster and FIG. 2b is a flowchart showing the change algorithm of the term cluster,

FIG. 3 shows a construction of a system for learning category using a genetic algorithm according to one embodiment of the present invention and for classifying term clusters not included in the category for category using it,

FIG. 4 shows a construction of a system for extracting a user interested field using a user profile according to one embodiment of the present invention, and

FIG. 5 shows a construction of a system for providing a category field related to a keyword to be retrieved by a user according to one embodiment of the present invention.

### DETAILED DESCRIPTION OF THE INVENTION

The present invention will be described in detail by way of a preferred embodiment with reference to accompanying drawings.

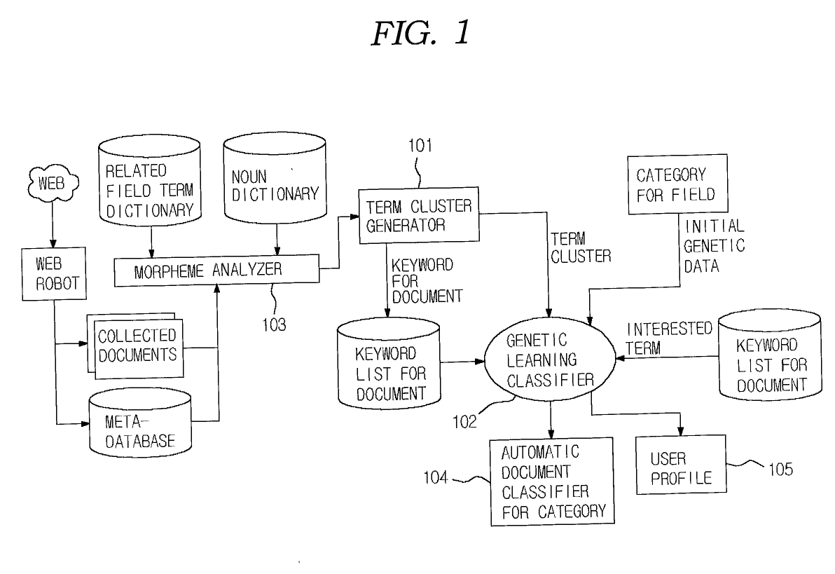

FIG. 1 shows an overall structure of an automatic document classification system according to one embodiment of the present invention. Fist, the automatic document classification system includes a web robot for collecting web documents, a morpheme analyzer 103 for pre-processing the documents, a term cluster generator 101 and a genetic learning classifier 102 for learning field categories.

The web robot collects a document from Internet. When the web robot collects the document, the subject of the link for connecting the web document is also collected. At this time, information collected by the web robot has the shape of a document or a meta-database.

Then, the collected document and the link subject are transferred to the morpheme analyzer 103 where related terms are extracted. At this time, during the extraction process, the morpheme analyzer 103 can refer to a related field term dictionary or a noun dictionary that are previously constructed.

The extracted term is inputted to the term cluster generator 101 wherein keyword for document is extracted and a term cluster is also constructed.

The genetic learning classifier 102 that learned the field category receives a keyword of the document to extract a term cluster for the keyword from the cluster index and then outputs a related field category deduced by the genetic learning classifier 102 for the extracted term cluster 104. Also, the learning system receives an interested term for a user profile and then determines the user's interested field through the previous procedure 105.

In particular, as the system learns only the field category to perform an automatic classification, the genetic learning classifier 102 does not have to repeat the learning process if the field category is not changed. Thus, the system has an advantage of providing service immediately without repeating the learning process.

Also, the morpheme analyzer 103 uses a noun dictionary and a related term dictionary to extract a noun from a link subject and a document. Further, the tenn cluster generator 101 outputs the total number of noun and the number of appearance of each of the nouns in the document, the noun appeared in the same paragraph and a keyword of the document. The extracted nouns consist of noun lists and the keyword for each of the documents is included in the keyword list for document.

Meanwhile, below [Equation 1] is used to extract the keyword.

Keyword=(the number of appearance of terms within a document)/(the mean number of appearance of term)*weight value [Equation 1]

The weight value includes a weight value for the term of the link subject and a weight value for the term within the document, wherein the weight value for the term of the link subject is set higher than the weight value for the term within the document.

At this time, if the keyword obtained by [Equation 1] surpasses a predetermined threshold value α, it is added to the keyword list.

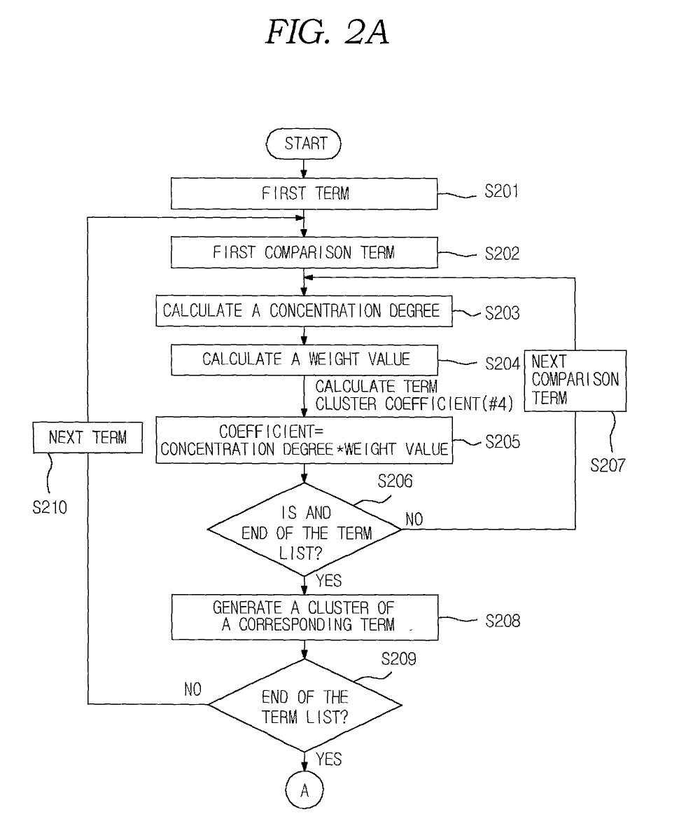

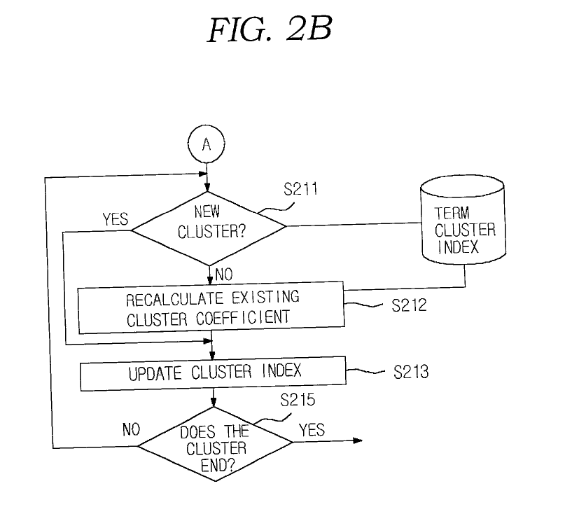

FIG. 2a and FIG. 2b are flowcharts of generating and changing algorithm according to one embodiment of the present invention.

First, if generation of a term cluster for the first term of the document is started (S201), analysis of a morpheme is started to select the first comparison term of the list included in the morpheme analyzer 103 (S202). Then, the concentration is calculated (S203).

Thereafter, the weight value is calculated (S204). The concentration and the weight value obtained in the steps (S203 to S204) are multiplied to calculate a term cluster coefficient. At this time, the equation calculating the cluster coefficient between term 1 and term 1 can be expressed as following [Equation 2].

weight value=(the number of appearance of term 1/the number of appearance of total terms)*(the number of appearance of term 2/the number of appearance of total terms) [Equation 2]

concentration=sqrt (the number times when the term 1 and the term 2 appear in the same sentence)

cluster coefficient=weight value*concentration

Then, it is determined whether the term list included in the morpheme analyzer 103 is an end or not (S206). If it is not the end, the process is returned to step (S203) wherein the same process for next comparison term is performed (S207). If it is the end, a cluster of a corresponding term is generated (S208).

Thereafter, in step (S209), it is determined whether the term of the document from which a cluster is to be generated is a last term or not. If it is not the last term, the process is returned to step (S202) wherein the same process for the last term is performed (S210). If it is the last term, the term cluster generation algorithm is completed and the process enters a nest term cluster change algorithm.

Referring now to FIG. 2b, the term cluster change algorithm will be explained below in detail.

First, it is determined whether the cluster generated by the term cluster generation algorithm is a new cluster or not (S211). If it is not the new cluster, the coefficient of existing cluster coefficient is updated (S212). At this time, the updating method can be calculated using following [Equation 3].

update cluster coefficient=(existing relevance*the number of change+new coefficient)/(the number of change+1) [Equation 3]

Then, the cluster index including the update cluster coefficient calculated in the step (S212) is updated (S213). Then, it is determined whether the cluster change is terminated or not (S215). As a result of the determination, if it is terminated, the cluster change is completed. If not, the process is returned to the step (S211).

Further, as the result of the determination in the step (S211), if there is a new cluster, the process proceeds to the step (S213) without performing the process of updating the existing cluster coefficient.

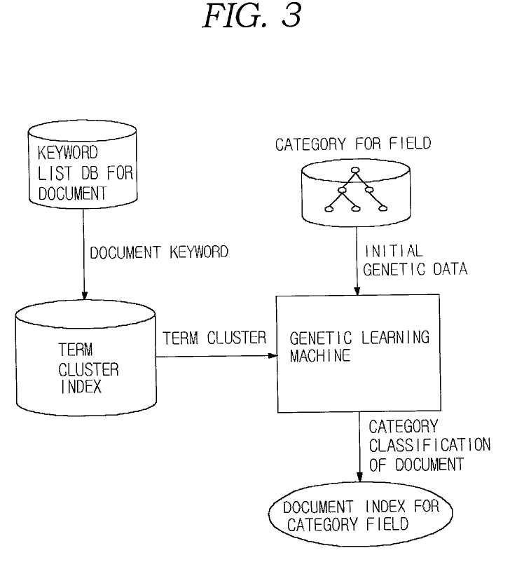

Referring now to FIG. 3, a system for learning field category using a genetic algorithm according to one embodiment of the present invention and for classifying term clusters not included in the field category will be below explained in detail.

For the keyword of the document to be classified, a term cluster is generated in the term cluster index. The generated term cluster is inputted to the genetic learning classifier (hereinafter called “genetic leaning machine”). Then, the genetic learning machine outputs a category related to the inputted term cluster. A document is registered in the outputted category field in the category field document index.

The genetic learning machine uses a genetic algorithm. The initial chromosome to be used in the genetic algorithm has a hierarchical structure of the category being represented as a binary tree format, and it uses each nodes (N) of the tree. Each of the nodes represents one category field and the evolution of the gene is performed to measure the similarity of the term cluster and each of nodes. Whether the gene has been evolved or not is determined by the fitness value. The fitness value is the similarity of the category field and the term cluster, which can be expressed into the following [Equation 4].

Fitness (CT??)=EF (N??) [Equation 4]

At this time, the term Fitness indicates the fitness value, CT?? indicates the term included in the classified category in N??, EF function indicates a function evaluating the relation between the function and the category and Ni indicates respective nodes of the genetic algorithm.

Next-generation chromosome performs a uniform inbreeding between the gene n/2 having the similarity value over the threshold value and the gene n/2 obtained by a variation of the genes having the similarity value over the threshold value among the genes in a different category field. This process is repeated to a predetermined maximum number α. After the generation evolution progress is completed, the generation having superior similarity value among the generations, that is, a field category is presented.

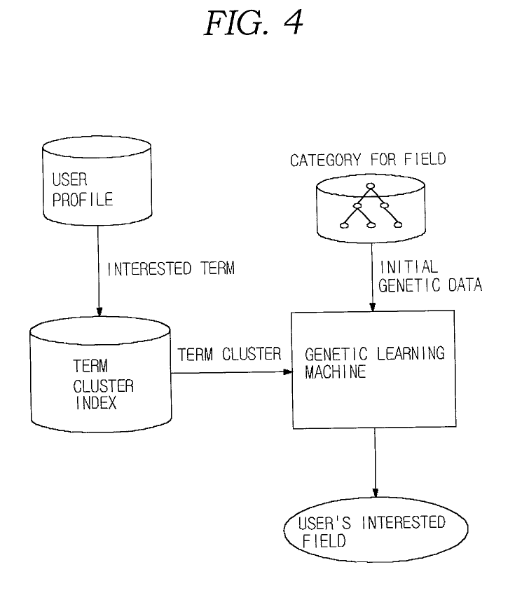

FIG. 4 shows a construction of a system for extracting a user's interested field using a user profile according to one embodiment of the present invention. Most frequently used search word is found depending on the retrieval date and the number of retrieval in the user retrieval list stored in the user profile. The search word thus found is inputted to the gene learning classifier 102, which then provides a category field that is determined to be interest field of the user.

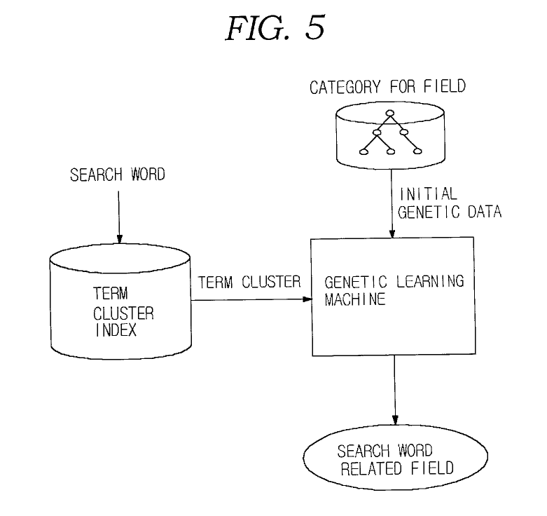

FIG. 5 shows a construction of a system for providing a category field related to a keyword to be retrieved by a user according to one embodiment of the present invention. The system generates a term cluster for the search word, inputs the generated term cluster to the gene learning machine and then outputs a category field related to the search word.

The characteristic of the present invention mentioned above can be summarized as follows.

First, documents are automatically classified by use of a category learning per field and a term cluster using a gene algorithm.

Second, the characteristic of the document is extracted in the morpheme analyzer.

Third, the category is learned to minimize the re-learning of the learning system.

Fourth, an interested field of a user is determined using the learned category.

Fifth, retrieved information classified per category for the search word is provided using the learned category.

As mentioned above, the present invention relates to one of data mining field. The present invention provides a system for learning a category per field using a gene algorithm, automatically classifying the document in conjunction with the tenn cluster (term clustering) and determining a user' interested field.

Therefore, the present invention can provide an immediate automatic document classification service using a learning system, allow a user to exactly search information that is to be found in the wet search from the document that is classified into categories, and easily obtain information since it can search information on the field interested by a user.

Therefore, the present invention has outstanding effects that it can provide an immediate and prompt service by reducing the time consumed in learning the document classification system using an artificial intelligence and thus can contribute an internet information search system-based technology improvement.

The present invention has been described with reference to a particular embodiment in connection with a particular application. Those having ordinary skill in the art and access to the teachings of the present invention will recognize additional modifications and applications within the scope thereof. It is therefore intended by the appended claims to cover any and all such applications, modifications, and embodiments within the scope of the present invention.

What is claimed:

1. A System for automatically classifying documents comprising:
a morpheme analyzer for receiving collected documents and link subjects to extract related terms;
a term cluster generator for receiving the terms extracted by said morpheme analyzer to extract keywords per document, generating a keyword list per document and generating a term cluster; and
a genetic learning classifier for receiving the keyword list and the term cluster generated by said term cluster generator to extract a term cluster for the keyword and for inducing a related field category for the extracted term cluster,
wherein said genetic learning classifier learns the field category using a gene algorithm.

2. The system according to claim 1, further including a web robot for collecting document from internet and collecting the subject of the link connected to the collected document.

3. The system according to claim 1, wherein said morpheme analyzer extracts a noun from the document and the link subject collected by the web robot, using a previously constructed noun dictionary and a term dictionary for related fields.

4. The system according to claim 1, wherein said term cluster generator extracts the total number of nouns in the inputted document, the number of appearance of each of the nouns, and the noun appeared in the same paragraph and a keyword of the document, wherein the keyword of each of the documents is included in the keyword list for document.

5. The system according to claim 4, wherein the number of appearance of the term within the document is divided by the mean number of appearance of the term and is then multiplied by a predetermined weight value, and when the resulting value is greater than a predetermined threshold value, the term of each document is determined to be a keyword.

6. The system according to claim 1, wherein said genetic learning classifier provides a user's interested category, by finding the most frequently used search word for a given period of time according to the retrieval date and the number of retrieval, from the user retrieval list stored in a predetermined user profile.

7. The system according to claim 6, wherein said genetic learning classifier outputs a search word inputted by the user and a related category field.

8. A method of generating and changing a term cluster in a system for automatically classifying documents by a category learning technique using a genetic algorithm and a term cluster, comprising:
a first step of extracting a term in a collected document and a term included in a previously constructed comparison term list;
a second step of calculating a term cluster coefficient using the value extracted in said first step;
a third step of generating a term cluster using the term cluster coefficient calculated in said second step; and
a fourth step of adding a term cluster index if the term cluster generated in said third step is a new term cluster, and updating an existing term cluster coefficient index and then adding the updated term cluster coefficient index to the term cluster index if the term cluster generated in said third step is not a new term cluster.

9. The method according to claim 8, wherein said second step calculates the term cluster coefficient according to the following [Equation 1]:
cluster coefficient=weight value*concentration [Equation 1]
concentration=sqrt (the number of times when a term 1 and a term 2 appear in the same sentence)
weight value=(the number of appearance of the term 1/the number of appearance of total terms)*(the number of appearance of the term 2/the number of appearance of total terms)

10. The method according to claim 8, wherein said fourth step updates the existing term cluster coefficient according to the following [Equation 2]:
update cluster coefficient=(existing relevance*the number of change+new number)/(the number of change+1). [Equation 2]

11. A method of automatically classifying documents, comprising:
a first step of receiving collected documents and link subjects to extract related terms;
a second step of receiving the terms extracted in said first step to extract keywords per document and generating a keyword list per document and a term cluster; and
a third step of receiving the keyword list and the term cluster generated in said second step to extract a term cluster for the keyword and for inducing a related field category for the extracted term cluster using a genetic algorithm.

12. The method according to claim 11, wherein said first step extracts a noun from the document and the link subject collected in said first step, using a previously constructed noun dictionary and a term dictionary for related fields.

13. The method according to claim 11, wherein said second step extracts the total number of nouns in the inputted document, the number of appearance of each of the nouns, and the noun appeared in the same paragraph and a keyword of the document, wherein the keyword of each of the documents is included in the keyword list for the document.

14. The method according to claim 13, wherein the number of appearance of the term within the document is divided by the mean number of appearance of the term and is then multiplied by a predetermined weight value, and when the resulting value is greater than a predetermined threshold value, the term of each document is determined to be a keyword.

15. The method according to claim 16, wherein said third step provides a user's interested category, by finding the most frequently used search word for a given period of time depending on the retrieval date and the number of retrieval, from the user retrieval list stored in a predetermined user profile.

16. The method according to claim 15, further including a substep of outputting a search word inputted by the user and a related category field.

17. The method according to claim 11, said second step further includes:
a first sub-step of extracting a term of a collected document and a term included in a previously constructed comparison term list;
a second sub-step of calculating a term cluster coefficient using the resulting value extracted in said first sub-step;
a third sub-step of generating a term cluster using the term cluster coefficient calculated in said second sub-step; and
a fourth sub-step of adding a term cluster index if the term cluster generated in said third step is a new term cluster, and updating an existing term cluster coefficient index and then adding the updated term cluster coefficient index to the term cluster index if the term cluster generated in said third sub-step is not a new term cluster.

18. The method according to claim 17, wherein said second sub-step calculates the term cluster coefficient according to the following [Equation 3];
cluster coefficient=weight value*concentration
concentration=sqrt (the number of time when a term 1 and a term 2 appear in the same sentence)
weight value=(the number of appearance of the term 1/the number of appearance of total terms)*(the number of appearance of the term 2/the number of appearance of total terms) [Equation 3]

19. The method according to claim 17, wherein said fourth step updates the existing term cluster coefficient according to the following [Equation 4];
update cluster coefficient=(existing relevance*the number of change+new number)/(the number of change+1). [Equation 4]

20. A computer-readable recording medium in which a program capable of executing a method of generating and changing a term cluster in a system for automatically classifying documents by a category learning technique using a genetic algorithm and a term cluster is recorded,
said program executes:
a first step of extracting a term in a collected document and a term included in a previously constructed comparison term list;
a second step of calculating a term cluster coefficient using the value extracted in said first step;
a third step of generating a term cluster using the term cluster coefficient calculated in said second step; and
a fourth step of adding a term cluster index if the term cluster generated in said third step is a new term cluster, and updating an existing term cluster coefficient index and then adding the updated term cluster coefficient index to the term cluster index if the term cluster generated in said third step is not a new term cluster.

21. A computer-readable recording medium in which a program is recorded,
said program executes:
a first step of receiving collected documents and link subjects to extract related terms;
a second step of receiving the terms extracted in said first step to extract keywords per document and generating a keyword list per document and a term cluster; and
a third step of receiving the keyword list and the term cluster generated in said second step to extract a term cluster for the keyword and for inducing a related field category for the extracted term cluster using a genetic algorithm;
wherein said third step further including:
a first sub-step of extracting a term of a collected document and a term included in a previously constructed comparison term list;
a second sub-step of calculating a term cluster coefficient using the resulting value extracted in said first sub-step;
a third sub-step of generating a term cluster using the term cluster coefficient calculated in said second sub-step; and
a fourth sub-step of adding a term cluster index if the term cluster generated in said third step is a new term cluster, and updating an existing term cluster coefficient index and then adding the updated term cluster coefficient index to the term cluster index if the term cluster generated in said third sub-step is not a new term cluster.
